(19) United States
(12) Patent Application Publication
(10) Pub. No.: US 2008/0077907 A1
(43) Pub. Date: Mar. 27, 2008

(54) Neural network-based system and methods for performing optical proximity correction

(76) Inventor: Anand P. Kulkami, Berkeley, CA (US)

Correspondence Address: GERALD B ROSENBERG;NEW TECH LAW, 260 SHERIDAN AVENUE, SUITE 208, PALO ALTO, CA, 94306-2009, US

(21) Appl. No.: 11/903,277

(22) Filed: Sep. 21, 2007

Related U.S. Application Data
(60) Provisional application No. 60/846,315, filed on Sep. 21, 2006.

(51) Int. Cl. G06F 17/50

(52) U.S. Cl. 716/20

(57) ABSTRACT

An optical proximity corrected mask design is generated from a given a target mask design by processing the target mask design through a feature trained neural network, configured to perform an optical proximity correction of geometric features, to obtain a representation of a first corrected mask design. The target mask design is processed in parallel through a rule processor, configured to perform placement of sub-resolution geometric features relative to geometric features in the target mask design, to obtain a representation of a second corrected mask design. A layout reassembler operates to generate a corrected mask design through an overlaid composition of said first and second corrected mask designs.

This application claims the benefit of U.S. Provisional Application No. 60/846,315, filed Sep. 21, 2006.

### BACKGROUND OF THE INVENTION

1. Field of the Invention

The present invention is generally related to lithographic photomask manufacturing and, in particular, to high-performance techniques for producing lithographic photomasks with optical proximity correction performed utilizing a neural network-based empirical rule inferencing process.

2. Description of the Related Art

In the design and fabrication of current generations of photomasks, as used in the lithographic processing steps in the manufacture of integrated circuits, optical proximity correction (OPC) is required to correct for optical interference effects due to the close proximity and feature size of the various lines and component structures represented by the mask. As integrated circuit fabrication processes have progressed well within the deep sub-micron range (less than 0.25 microns), various OPC approaches have been employed to pre-compensate or ‘correct’ reticle mask patterns so that the realized image fidelity at the surface of the integrated circuit will yield, through the fabrication process, the desired structures. Ideally, the correction will account not only for optical interference effects, but also for the effects of photoresist, etch, and diffusion processing, as well as lens aberrations, mask imperfections, and multiple light sources, that may result in feature distortion variously due to line position fidelity errors and line end pullback. Failure to achieve adequate OPC will result in a reduction in production yield or a limitation in the topological feature densities that can be achieved.

Model-based OPC (MBOPC), commonly used in preference to the earlier, simpler rule-based OPC methods, is premised on the recognition that a direct inverse lithography solution is not subject to mathematical description. In summary, model-based OPC is implemented as a nonlinear feedback and control system that models, through a physics-based simulation, the optical interference at a surface given an original target mask design. As part of a progressive, error-reduction feedback loop, the reticle mask design is iteratively adjusted until the target mask design is imaged at the surface within a given tolerance error. Specifically, the position of each line segment, end or other feature is adjusted toward or away from a prior iteration position in order to evaluate error variation. Given the highly non-linear nature of interference interactions, particularly in the presence of complex and topologically dense features, the iterative adjustments are selected through a randomized approximation process. The eventual resultant adjusted reticle mask design is the corrected mask design.

The complexity of model-based OPC is significantly increased where the reticle mask designs are to be used in multiple exposure, phase-shifted configurations. Even in single exposure, non-phase shifted configurations, model-based OPC is highly computationally intensive, even for target mask designs of modest complexity. The addition of scatter-bars and other sub-resolution optical features is a technique conventionally used to reduce the fundamental complexity of model-based OPC. Appropriate selection and placement of these features in the reticle mask design will tend to compensate for and cancel out various undesired optical interactions. Unfortunately, the selection and placement of scatter-bars and other sub-resolution features are also computationally intensive. While techniques exist to allow division and parallelization of model-based OPC computations, modeling error rates are inherently increased due to the truncation of interference interactions at division boundaries.

In conventional application, large numerical processing arrays, involving tens to hundreds of concurrent processing servers operating over periods typically measured in days if not weeks, are used to solve single model-based OPC target mask correction problems. These periods are further compounded by the requirement for multiple corrected mask designs representing the different process parameters inherent in different semiconductor manufacturing lines. While not directly a part of the OPC computational problem, corrected mask preparation is typically paired with extensive pre- and post-OPC manufacturing tests to both determine appropriate parameters to feed into the physics-based simulation model and to empirically verify the fidelity and manufacturability of the pattern while adjusting for effects not covered by the model. These manufacturing tests are labor-intensive and slow, and must be repeated for each candidate corrected mask design until a final version is reached. Given that each different technological design node, such as 65 nanometers, 45 nanometers, and 32 nanometers, is expected to process many thousands of individual semiconductor circuit designs, each requiring five to fifteen different corrected masks, the production of corrected photomasks is well-recognized as major limitation in the semiconductor fabrication chain.

Consequently, there is a clear need for an OPC strategy that reduces the severe computational costs and other limitations of model-based OPC.

### SUMMARY OF THE INVENTION

Thus, a general purpose of the present invention is to provide for computationally and process efficient neural net-based OPC correction of target lithography mask designs.

This is achieved in the present invention by providing for the generation of an optical proximity corrected mask design from a given target mask design by processing the target mask design through a feature trained neural network, configured to perform an optical proximity correction of geometric features, to obtain a representation of a first corrected mask design. The target mask design is processed in parallel through a rule processor, configured to perform placement of sub-resolution geometric features relative to geometric features in the target mask design, to obtain a representation of a second corrected mask design. A layout reassembler operates to generate a corrected mask design through an overlaid composition of said first and second corrected mask designs.

In preferred embodiments, the feature trained neural network is prepared through the application of supervised training derived from an established pair of training target and training corrected mask designs. The training process includes scanning, in correspondence, a training target mask design representing a known layout geometry, and the training corrected source mask design, representing a known corrected layout geometry, to define respective sequential pluralities of training windows representing geometry subsets of the training target and corrected mask designs. The geometry subsets are encoded, subject to selection of a predetermined defined subset of said geometry features, as input matrices that are then applied to the feature trained neural network as the supervised training data. Preferably, an initial step in training excludes sub-resolution geometric features from consideration in the training of the feature trained neural network. A parallel step is preferably performed to consider the patterns of the excluded sub-resolution geometric features relative to the included non-sub-resolution geometric features and create a corresponding rule base. In preferred embodiments, the rule base is constructed as a sub-resolution feature trained neural network.

New corrected mask designs are preferably generated through a process that includes scanning a new target mask design, representing an uncorrected layout geometry, to define a sequentially overlapping plurality of windows representing geometry subsets of the target mask design. Each window will encompass a plurality of geometry features that are then selectively encoded into matrices that can be applied to the feature trained neural network to produce, subject to decoding, a like plurality of corrected geometry windows encompassing corrected geometry features. The corrected geometry windows are assembled in overlapping sequence to provide the corrected mask design corresponding to the uncorrected layout geometry. The new target mask design is also preferably processed in parallel, subject to a corresponding sequential window scanning, through the sub-resolution feature trained neural network to produce a corresponding series of geometry windows containing added sub-resolution features. The reassembly step incorporates sub-resolution features in the generation of the corrected mask design.

An advantage of the present invention is that the system and methods provide for a neural net-based OPC that is computationally efficient in the production of a corrected mask for a given design node and integration process. The corrected mask design produced represents a direct inverse of the lithographic process for a target mask design. While initial use at a design node and process is dependent on the availability of target and conventionally OPC corrected mask designs for training, subsequent use can be achieved without necessary resort to conventional OPC systems. Corrected mask designs produced through use of the present invention, subject to verification and integration testing, can then be used as subsequent training, enabling further improvement in the direct generation of corrected mask designs.

Another advantage of the present invention is that neural net-based OPC and model-based OPC can be used serially to produce a corrected mask design from an initial target mask while incurring a fraction of the computational overhead of a solely model-based OPC process. Where a corrected mask design produced by neural net-based OPC is determined not immediately appropriate for use, the neural net corrected mask design can then be used to initialize a model-based OPC process, thereby substantially reducing the computation requirements of the model-based OPC process in reaching a final corrected mask design. Confidence information produced through the neural net-based OPC process is used as a basis in determining the likely quality of neural net-based OPC produced corrected mask designs. Application of model-based OPC can also be used in verification of the quality of a neural net-based OPC corrected mask design.

A further advantage of the present invention is that the neural net-based OPC process efficiently utilizes multiple neural networks operated in series and parallel configurations to efficiently handle different OPC significant geometry features. Separate feature handling can reduce training complexity as well as the optimal dimensionality of the neural network. Separate handling of ordinary resolution and sub-resolution features particularly reduces training complexity as well as the size of the encoded representations of layout geometry that is to be processed through a neural network. Selection and placement of scatter-bar and other sub-resolution features are performed in a parallel neural net-based OPC correction process that produces geometry that is integrated in a layout reassembly process phase to produce a completed neural net-based OPC corrected mask design. A sequential series of neural net-based OPC correction processes can also be used to generate a corrected mask design, where each stage utilizes a different neural network trained to correct for a different full resolution feature distinguished based on geometry orientation, shape, or type.

Still another advantage of the present invention is that the neural net-based OPC correction process operates over selected local feature domains for lithography inversion. A kernel window is scanned in overlapping steps over the geometry of a target mask design to select local feature domains for inversion. An equivalent scan sequencing is used to train on a production verified pair of target and corrected mask designs. New target designs are processed using the same scan sequence parameters with the production output of the neural network being further processed through a layout reassembly step to produce the neural net-based OPC corrected mask designs. Computational parallelization is performed based on scan window instances. Since the neural network training is equivalently partitioned, separate inversion processing of scan windows does not introduce error into the neural net-based OPC process of the present invention.

### BRIEF DESCRIPTION OF THE DRAWINGS

FIG. 1 is a block diagram of a computer system appropriate for implementing single system and parallel server implementations of the neural net-based OPC processes of the present invention.

FIG. 2 is a block diagram illustrating the architectural implementation of a neural net-based OPC system configured for training based on a defined pair of target and corrected mask designs in accordance with a preferred embodiment of the present invention.

FIG. 3 provides a representative illustration of an integrated circuit mask design, a kernel window-based scan process for examining the geometric structures represented by the mask design, and a decomposition of a kernel window sample for processing in a preferred embodiment of the present invention.

FIG. 4 is a representative illustration of a neural network as used in a preferred embodiment of the present invention.

FIG. 5 is a flow diagram of a neural net-based OPC system training process as implemented in a preferred embodiment of the present invention.

FIG. 6 is a flow diagram description of mask geometry encoding process as implemented in a preferred embodiment of the present invention.

FIG. 7 is a block diagram illustrating the architectural implementation of a trained neural net-based OPC system configured for the production of corrected mask designs from target mask designs in accordance with a preferred embodiment of the present invention.

FIG. 8 is a flow diagram of a neural net-based OPC system corrected mask design production process as implemented in a preferred embodiment of the present invention.

FIG. 9 is a flow diagram description of a mask geometry decoding process as implemented in a preferred embodiment of the present invention.

FIG. 10 is a system flow diagram illustrating a compound use of a neural net-based OPC system in series with model-based OPC system in accordance with a preferred embodiment of the preset invention.

### DETAILED DESCRIPTION OF THE INVENTION

The present invention provides for correction of the topological layout of geometric features present in optical projection masks used in the fabrication of integrated circuits. Multiple different physical masks are used in semiconductor fabrication processes that can conventionally involve upwards of forty different process steps. Each physical mask is defined characteristically by a computer-based design tool data file that is rendered in the manufacture of the physical mask. The present invention provides for the correction of the defining data file representation of the physical mask. In the following description, the term mask design will be used to refer to, appropriate to context, the computer-based data file representation of a physical mask. Further, the term optical proximity effect (OPE) will, appropriate to context, refer to the collection of effects, including resist internal diffraction, resist curing and removal variances, etch and diffusion related anisotropies, in addition to optical interference effects, that may be accounted for in the correction of a particular mask design, typically as dependent on the fabrication processes steps associated with the use of a particular mask. For ease of discussion, like reference numerals will be used in the following detailed description of the invention to designate like parts depicted in one ore more of the figures.

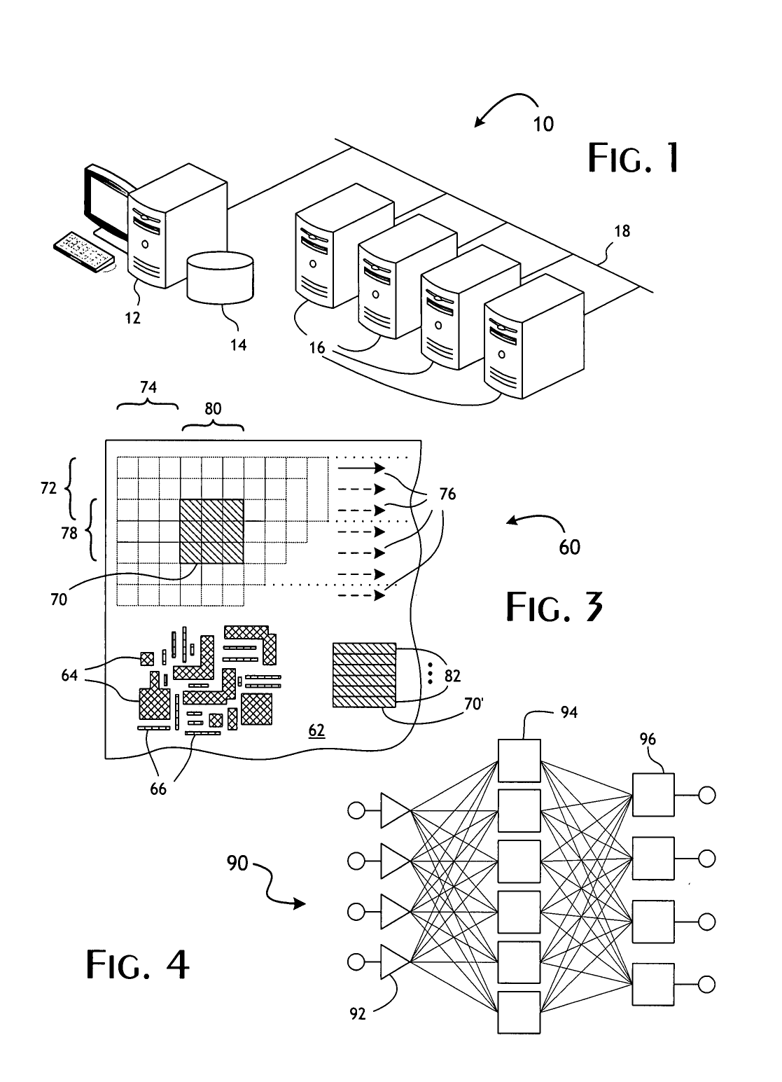

FIG. 1 depicts a computer system architecture 10 suitable for the production use of the methods of the present invention. In simple installations, a workstation class computer system 12 with a local persistent data store 14 can be employed to perform the processes required to process an original design tool generated mask design, a target mask design, to produce an OPE corrected mask design. In anticipated production environments, an array of server computer systems 16, mutually interconnected through a network 18 and managed by the workstation 12, can be operated as a compute intensive grid computer system for performing the processes of the present invention. The server systems 16 can be conventional server class computer systems, employ hardware-based neural network accelerators, or be specifically adapted to performing neural network-based compute operations.

As implemented in the preferred embodiments, the present invention performs a feature selective local lithography inversion performed utilizing a trained neural network to compute, from a given mask design, a corresponding OPE corrected mask design. The training is specific to a particular design node and the process parameters of a particular semiconductor process. The training is preferably further specific to the particular fabrication level process step that utilizes the mask. In accordance with the present invention, the required training is at least initially obtained utilizing a conventional model-based OPC process, including addition of scatter-bar and other sub-resolution features, rule-based pattern verification and fabrication test-based refinement. A training mask design will therefore include a target mask design and a preferably production qualified corrected mask design, both for the same fabrication process level.

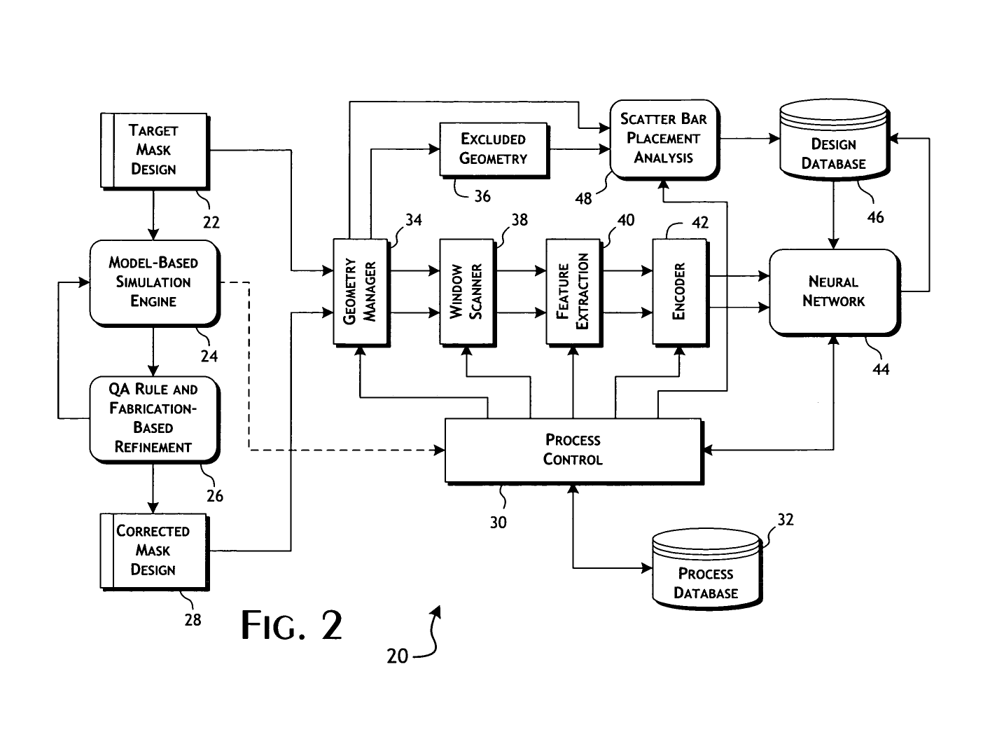

A preferred implementation of a neural network training system 20, appropriate for use in performing the present invention, is shown in FIG. 2. An initial training mask design is produced from a target mask design 22 that is processed through a conventional model-based simulation engine 24. The proto-corrected mask design is then subjected to conventional quality assurance rule-based pattern verification and fabrication test-based qualification and refinement 26 with any necessary model parameter changes being returned to the model-based simulation engine 24. A corrected mask design 28, preferably qualified for production use, will be eventually cleared through verification and refinement 26.

With the submission of the target 22 and corrected 28 mask designs for training, design node, process parameter, mask fabrication level, and other information is passed to a process controller 30, used to manage the training process. This information is stored in a process database 32 for subsequent reference in relation to the neural network training.

A geometry manager 34 preferably implements a selective filter, controlled by the process controller 30, that removes one or more defined categories of geometric features from the corrected mask design. For the preferred embodiments of the present invention, the geometry manager 34 operates to remove scatter-bar and other sub-resolution features from the corrected mask design 28. As generally shown in FIG. 3, relative to a representative image of a mask layout 62 defined by a corrected mask design, layout features 64 having counterparts in a target mask design are distinguished from sub-resolution features 66 placed by operation of the model-based simulation engine 24 in implementing conventional resolution enhancement technique (RET) operations. Sub-resolution feature location information, as captured by the model-based simulation engine 24, is provided to the process controller 30. Excluded geometry is preferably captured and kept 36 in a positionally correct sub-resolution mask design representation.

A window scanner 38 preferably implements a sequential mask design data scan operation. As generally illustrated in FIG. 3 with respect to the representative mask layout 62, a kernel window 70 is defined to scan mask designs by overlapping rows and columns 72, 74 in X-Y sequential posses 76. As representatively shown, the window 70 is in a third X-axis 78, forth Y-axis 80 pass 76 in the scan process. The scan window size is defined specific to a design node, further particular to the process mask exposure frequency, to preferably capture the OPE radius of influence relative to a window central geometric feature, nominally categorized as including a corner, serif, jog, cut, or similar discrete layout geometry defining feature. For example, at a 65-nanometer design node, using 193 nanometer exposure light, a fixed-size kernel window will be chosen to be between about 600 and 2000 nanometers square and more typically between 800 and 1600 nanometers. For 157 nanometer exposure light, the kernel window size will be significantly smaller. The chosen size of the window kernel is fixed for the training and subsequent use of a particular trained neural network. The scan overlap is preferably chosen as a symmetric fixed value that represents a guard band that is from two to twenty percent of the kernel window height, preferably on the order of five to ten percent. The scan overlap value is, like the kernel window size, also fixed for the training and subsequent use of a particular trained neural network. Increasing the size of the scan overlap will increase the training obtainable from each set of target and corrected mask designs 22, 28 and the potential accuracy of OPE training and eventual correction of the core area within the guard band.

A feature extractor 40 preferably operates to identify X and Y coordinate vertices values for each of a defined set of geometric features found to occur within a kernel window at a particular X- and Y-axes scan step. The set of geometric features recognizable by the feature extractor 40 is established by the process controller. The feature set can be defined to include all of the features included by operation of the geometry manager 34, including corners, serifs, jogs, cuts, and similar discrete features. Alternately, only a subset may be recognized for use in training one of a set of neural networks, each trained to recognize a different set of features, that can be subsequently used in serially generating a fully corrected mask design.

An encoder 42 processes the recognized layout geometry that occurs within a kernel window preferably to create a 2-dimensional input matrix appropriate for presentation to a neural network 44. Supervised training is performed by presenting positionally corresponding scan input window derived input matrices from both the target mask design 22 and corrected mask design 28.

Various encodings can be used to convert vertices-based location information into input matrix values. In a first preferred embodiment, each kernel window 70′ scanned from a mask design 22, 28 can be subdivided into a series of fixed-width segments 82. Within each segment 82, representing a matrix row, the inter-edge distances between each pair of vertices defined edges can be encoded as matrix column values. In a second preferred embodiment, a genetic algorithm of the form described in The Novel Approach for Optical Proximity Correction Using Genetic Algorithms, Matsunawa et al., Proc. of SPIE Vol. 5992, 599254 (2005), can be used to determine a best regular fit of floating placeable rectangles that, in union, represent the layout geometry within individual kernel windows 70′. For training purposes, the genetic algorithm is applied separately to the kernel windows derived from the target mask design 22 and corrected mask design 28. The dimensions and window relative position of each found rectangle are captured as the input matrices values. In a third preferred embodiment, the input matrices can be constructed of values representing inter-feature distances between each pair of feature elements, as represented by the extracted vertices sets, within individual kernel windows 70′. In a fourth preferred embodiment potentially having the highest probability of success for highly topologically dense and varied layout geometries, a complementary neural-network autoencoder of the form described in New Life for Neural Networks, Cottrell, G. W., Science Vol. 313, pg 454-455, may be used.

The neural network 44 is preferably constructed as a 2-dimensional multilayer back-propagation feedforward neural network, represented for simplicity as a 1-dimensional network 90 in FIG. 4. Preferably, the network neurons implement a sigmoid activation function. An input node array 92 is coupled to one or more hidden layers 94 that, in turn, connect to an output node array 96. The dimensionality of the input and output node arrays 92, 94 is preferably chosen to match the dimensions of the input matrices. The number of hidden layers is determined empirically, as is conventional for neural networks. Preferably, the input and output node arrays 92, 94 will include from 10³ to 10⁶ nodes and from two to seven hidden layers will be determined optimal. The training data compiled by the neural network 44 is persisted to a design database 46 referenced to the design node, process parameters, and other process control information stored by the process database 32, as collected and managed by the process controller 30. Existing training data can be used to initialize the neural network to collect further training.

A preferred process 100 of training a neural network 44 in accordance with preferred embodiments of the present invention is shown in FIG. 5. A fabrication level corresponding pair of training mask designs 22, 28 are initially retrieved 102. The corrected mask design 28 is selected and processed to exclude selected features 104. In the preferred embodiments, the scatter-bar and other sub-resolution features 66 are located and removed from the corrected mask design 28. The removed sub-resolution features 66 are preferably positionally preserved in a RET mask design buffered as excluded geometry 36. The window scanner 38 processes 106 both the original training target mask design 22 and the modified corrected mask design 28′. Functionally in parallel, kernel windows 70 are scanned through the mask designs 22, 28′ with positionally corresponding windows 70 from the mask designs 22, 28′ being presented to the feature extractor 40.

Layout geometries occurring within positionally corresponding windows 70 are then processed 108 to recognize and encode layout features into input matrices appropriate for presentation to the neural network 44. A preferred generalized process 130 of encoding recognized features is further detailed in FIG. 6. For encoding algorithms that will rely on row subdivision of the windows 70, band segments 82 are determined 132, preferably based on minimum geometric feature heights, for positionally corresponding windows 70′ from the mask designs 22, 28′. Layout geometry that cross segment boundaries are adjusted 134 to create discrete closed polygons.

Independent of whether segment bands 82 are defined, feature extraction is then performed 136, constrained to recognize a defined set of layout geometry features determined by the process controller 30. In the preferred embodiments, the feature extractor will recognize a full complement of layout geometry relevant features, including corners, serifs, cuts, and jogs. Alternatively, subsets of the layout geometry relevant features are selected for recognition with the understanding that additional neural networks 44 will need to be trained on the remaining features. Feature extraction operates 138 to produce sets of feature defining vertices further associated, as appropriate, with specific bands 82 for positionally corresponding windows 70′ from the mask designs 22, 28′.

The sets of feature defining vertices are then encoded 140 consistently using any of the encoding algorithms discussed above or other conventional encoding algorithms. Where the vertices are associated in bands 82, each encoded band set of vertices represents an input matrix row, resulting in the generation 142 of two-dimensional input matrices representing the positionally corresponding windows 70′ of the mask designs 22, 28′. Otherwise, the encoding 142 of the vertices directly generates two-dimensional input matrices.

The encoded input matrices are then applied as supervised training to the neural network 44. Neural network training is preferably monitored 112 by the process controller 30 to evaluate convergence as a measure of the adequacy of training. All of the positionally corresponding windows 70 of the mask designs 22, 28′ are iteratively processed 114 through feature detection and encoding 108 and training 110. The data set representing the trained neural network 44 can then be persisted to the design database 46.

Referring again to FIG. 2, in the preferred embodiments of the present invention, the RET mask design, as extracted from the corrected mask design 28 and buffered 36, is processed logically in parallel through a separate sub-resolution feature rules engine 48 under control of the process controller 30. The sub-resolution feature rules engine 48 preferably operates to recognize the selection and placement rules represented by the observed features present in the RET mask design relative to the target mask design 22 and may be implemented using any of a number of different logic and expert systems. In preferred embodiments of the present invention, the sub-resolution feature rules engine 48 is implemented as a neural network system trained using a variant of the neural network training system 20. As indicated in FIG. 5, rather than processing the target and modified corrected mask designs 22, 28′, training of a separate sub-resolution feature neural network 44′ is performed 118 based on the target 22 and RET mask designs. The training process of steps 106 through 114 are performed adjusted with respect to recognition of the type and relative placement of the sub-resolution features relative to the existing features of the target mask design 22. The data set representing the trained sub-resolution feature neural network 44′ is then persisted 116 in the design database 46 associated with the trained neural network 44 data set.

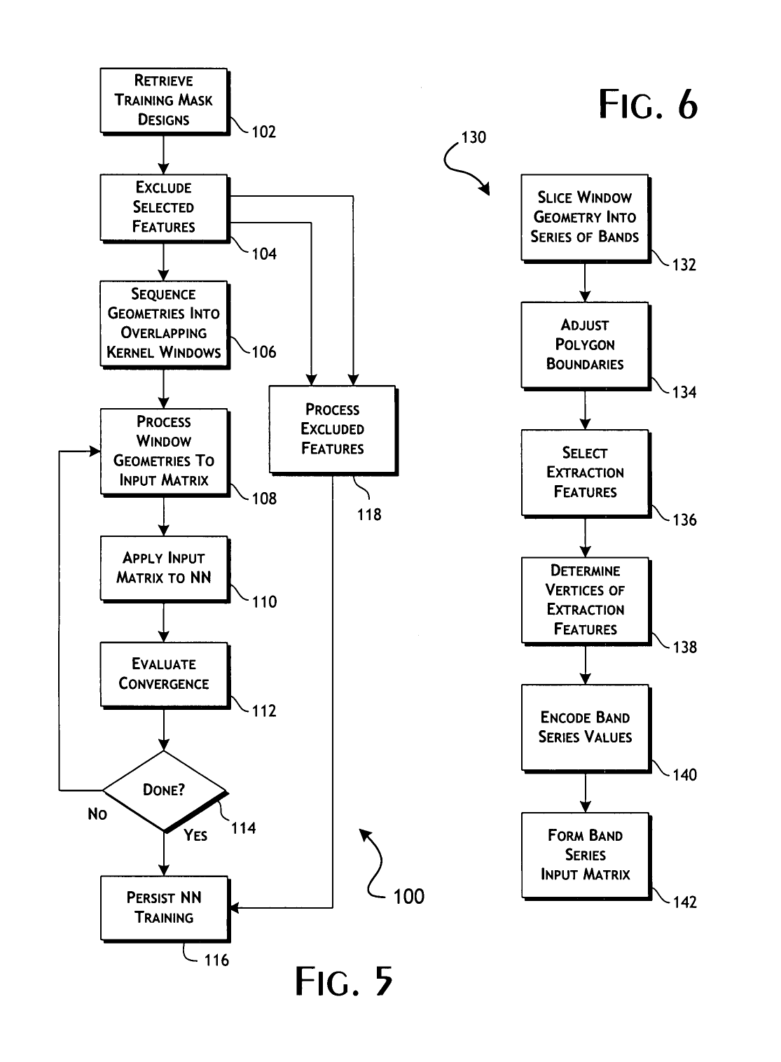

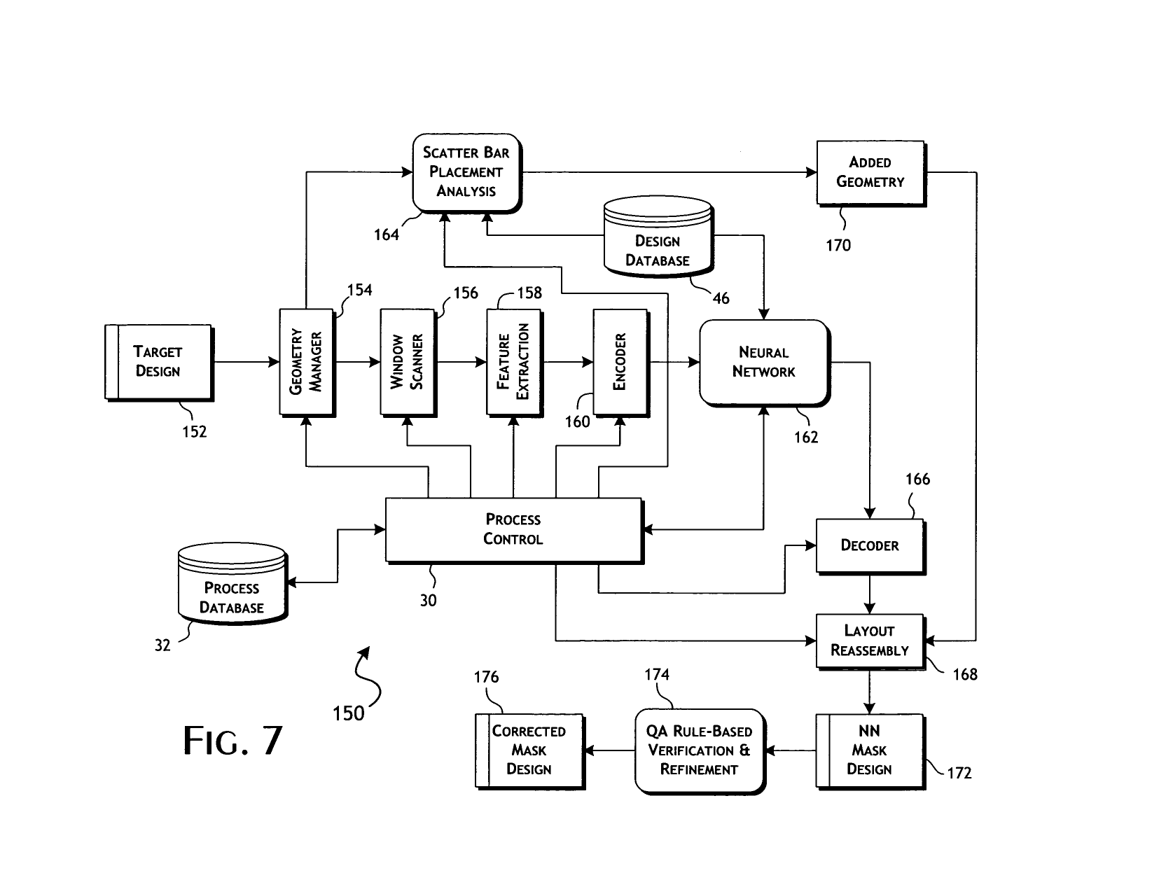

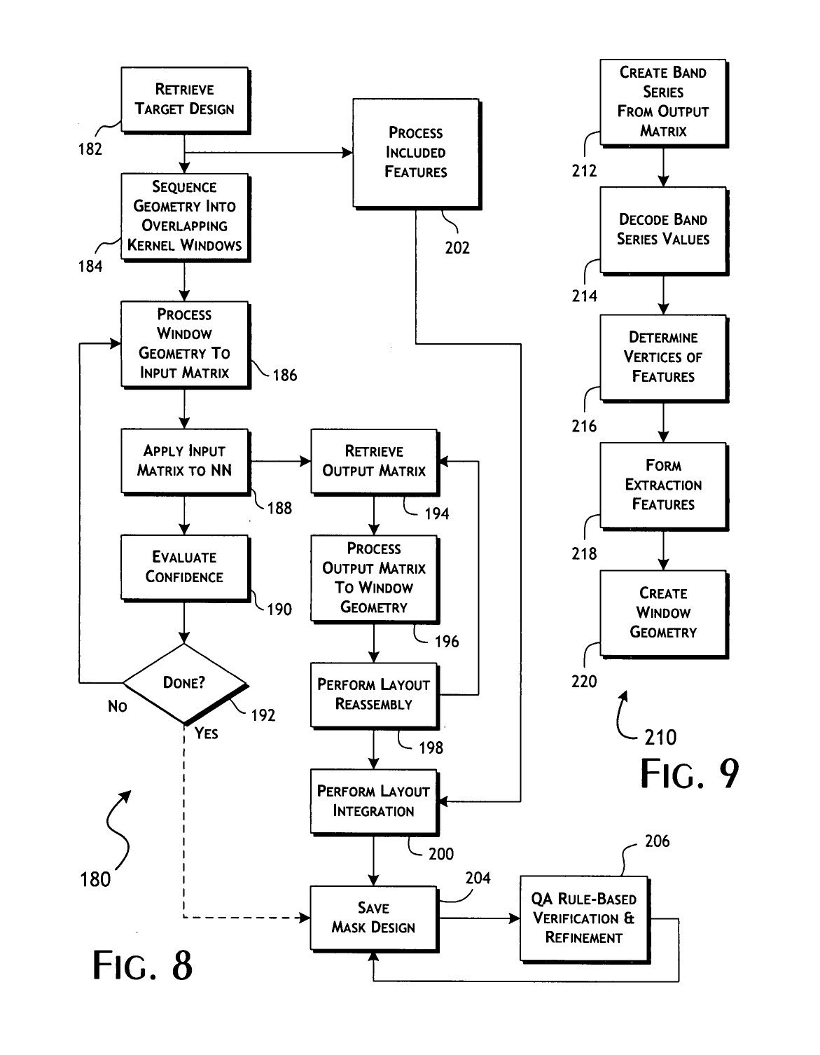

A preferred implementation of a neural network-based OPC system 150, appropriate for the applied use of the present invention, is shown in FIG. 7. A new target design 152 for which a neural network-based OPC mask design is to be generated, is preferably processed through a geometry manager 154, window scanner 156, feature extractor 158, encoder 160, and production neural network 162 that function similar to the corresponding elements of the neural network training system 20, though only operating on a single mask design. Other differences include the geometry manager 154 operates to route, without performing feature exclusion, a copy of the target mask design 152 to a sub-resolution feature rules engine 164, and the neural network 162 is initialized with the data set constructed from the training of the neural network 44.

A decoder 166 provides for the reconstruction of window kernel layout geometries from output matrices received from the production neural network 162. The decoder 166 operates, under control of the process controller 30, complementary to the encoder 160 and feature extractor 158. A layout reassembly processor 168 operates to composite the sequence of kernel window layout geometries received from the decoder. The reassembly, also performed under the control of the process controller 30, positionally matches the kernel window scanning operation implemented by the window scanner 156. In addition, the layout reassembly process 168 receives RET geometry features from an added geometry buffer 170 as produced by the sub-resolution feature rules engine 164. Preferably the RET geometry features are presented in a manner that allows a functional overlay compositing of the RET geometry features with the scan composited window kernel layout geometries received from the decoder. The result of the compositing is an OPE corrected neural network-based mask design. Conventional quality assurance rule-based pattern verification and fabrication test-based qualification and refinement 174 may then be performed to produce a production qualified corrected mask design 176. Alternately, the RET geometry can be incorporated through the serial processing of the input matrices through the production neural network 162 and sub-resolution feature rules engine 164.

A preferred process 180 of operating the neural network-based OPC system 150 in accordance with the present invention to generate and OPE corrected mask design is shown in FIG. 8. A new target mask design is retrieved 182 and scanned 184 using the kernel window size and related parameters using in the training of the production neural network 162. The layout geometry selected at each kernel window scan step is further processed and encoded to generate 186 a corresponding input matrix. Feature extraction and encoding is performed consistent with the encoding process 130, further using the specific encoding algorithm used in the creation of the training data set used to initialize the production neural network 162. The input matrices are iteratively applied 188 to the production neural network 163, accumulating confidence values 190, until the entire series of scanned kernel windows 70 have been processed 192.

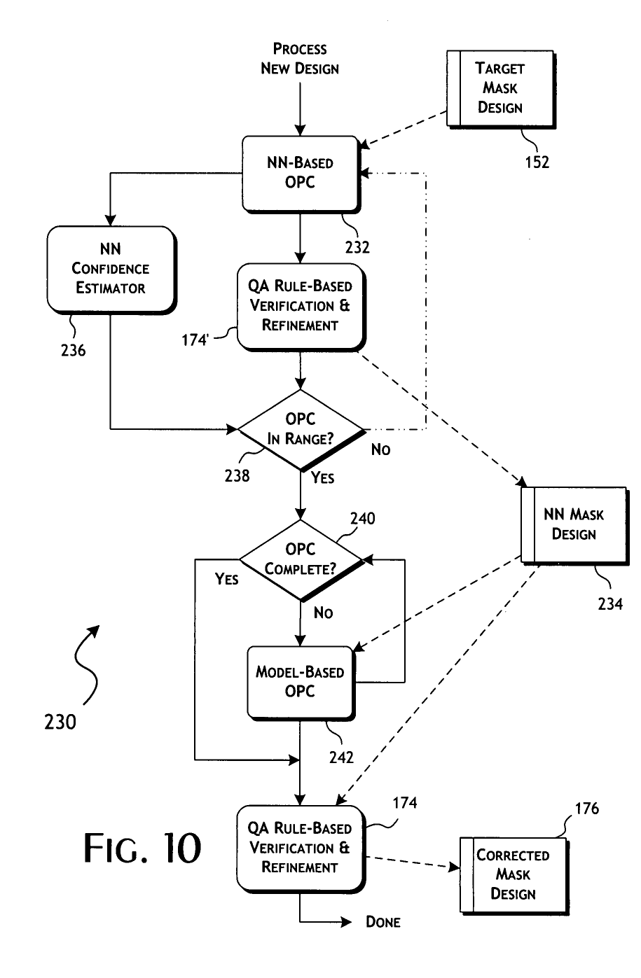

As each input matrix is applied to the production neural network 162, an output matrix is retrieved 194 and processed 196 to decode and form an OPC kernel window of layout geometry. Preferably, a decoding process 210, as shown in FIG. 9, performs a functional inverse of the feature extraction and encoding process 130. As appropriate to the chosen encoding algorithm, the rows of an output matrix are associated as bands 212 prior to the decoding 214 of the values present in the output matrix. The decoded information, representing layout geometry vertices and edges 216, is further processed to representatively form each of the OPE corrected layout geometry features 218, 220 within a scan kernel window 70. The scan order conforming sequence kernel window layout geometries are successively assembled 198. The assembly process preferably utilizes geometric feature matching within the guard band overlaps to establish precision alignment. The guard band portions of the OPC kernel windows are then removed, allowing the remaining positionally abutting core areas to be progressively merged as a primary feature neural network-based OPE corrected mask design.

In the preferred embodiments of the present invention, a sub-resolution OPE mask design, representing the buffered RET geometry features 170, is produced functionally in parallel with the primary feature neural network-based OPE corrected mask design. The sub-resolution feature rules engine 164 operates to process 202 the included layout geometry features present in the target design 152 to produce the sub-resolution OPE mask design that permits topological integration 200 with the primary feature neural network-based OPE corrected mask design. In the preferred embodiments of the present invention, the sub-resolution OPE mask design process 202 is performed using the primary elements 156 through 162, 168 of the neural network-based OPC system 150 to perform steps 184 through 198 utilizing the target mask design 152 as input and utilizing the training data set persisted from the sub-resolution feature neural network 44′ as the initialization data set of a sub-resolution feature production neural network 162′. The resulting corrected neural network-based mask design is then persisted 204 and made available for subsequent use in the creation of a physical mask. In an alternate embodiment, the sub-resolution feature neural network 44′ is trained utilizing the corrected mask 28, subject to exclusion of sub-resolution features, and the excluded OPC sub-resolution features 36′ as the training inputs. The resulting neural-network data set from the sub-resolution feature neural network 44′ can then be employed in serially processing the input matrices through the production neural network 162, using the neural network 44 data set, and sub-resolution feature production neural network 162′ to obtain the retrieved output matrices 194. In this manner, the sub-resolution features will be directly present in the OPE corrected layout geometry windows 220, removing the requirement for a separate layout integration 200. Conventional rule-based verification and, potentially, test fabrication refinements 206 can be determined and applied as final adjustments to the corrected neural network-based mask design.

As illustrated in FIG. 10, the present invention provides for a further improvement on the neural network-based OPC process 180 through a compound process 230 that serially combines neural network-based OPC and model-based OPC processes. The compound process is performed by initially processing the target mask design 152 through a neural network-based OPC system 232 corresponding to the system 150. The resulting preliminarily corrected mask design is then subjected to conventional rule-based pattern verification and refinement 174′, producing a neural network-based OPE corrected mask design 234. The quality of the neural network-based OPE corrected mask design 234 is assessed based on the results of pattern verification 174′ and a confidence estimator 236 that evaluates the confidence values produced during operation of the neural networks 162, 162′. If the threshold quality of the neural network based OPE corrected mask design 234 is insufficient 238, further training of the neural networks 44, 44′ will be required.

Provided a threshold quality is achieved, a further determination may be made 240 as to whether further processing is required or desired. If no further processing is performed, the neural network-based OPE corrected mask design 234 is processed through final quality assurance rule-based pattern verification and fabrication test-based qualification and refinement 174 to produce the corrected mask design 176.

Preferably, however, where the quality of the neural network-based OPE corrected mask design 234 is considered at least adequate, a number of model-based OPC iterations are performed 242 to judge whether the quality of the neural network based OPE corrected mask design 234 can be further improved. Improvement is evaluated on the degree of change introduced through execution of the model-based OPC process 242 relative to the neural network based OPE corrected mask design 234. Where an empirically determined threshold degree of change is recognized, the model-based OPC process 242 is continued until the degree of feature relocation is reduced below a conventional correction threshold. Even where some number of significant model-based OPC process 242 iterations are performed, functional initialization of the model-based OPC process 242 through use of the neural network-based OPC system 232 will be substantially reduced relative to conventional systems. Where changes are introduced through operation of the model-based OPC process 242, the correspondingly modified neural network-based OPE corrected mask design 234 is processed through final quality assurance rule-based pattern verification and fabrication test-based qualification and refinement 174 to produce the corrected mask design 176.

Thus, a system and methods for efficiently producing optical proximity corrected mask designs has been described. Additionally, the training process can be used directly to evaluate the quality of existing OPC mask designs, typically as produced using other methods. The confidence values produced by the neural network 44 in performing an independent quality assurance check on a presented pair of mask designs 22, 28 can be evaluated to determine the OPC quality. In view of the above description of the preferred embodiments of the present invention, many modifications and variations of the disclosed embodiments will be readily appreciated by those of skill in the art. It is therefore to be understood that, within the scope of the appended claims, the invention may be practiced otherwise than as specifically described above.

1. A method implemented on a computer system of determining an optical proximity corrected mask design given a target mask design, said method comprising the steps of:
a) scanning a target mask design representing an uncorrected layout geometry to define a sequentially overlapping plurality of windows representing geometry subsets of said target mask design, wherein each said geometry subset includes a plurality of geometry features;
b) encoding, for each said geometry subset, a predetermined defined subset of said geometry features as respective input matrices;
c) processing said respective input matrices through a neural network;
d) decoding, from said neural network, a plurality of output matrices, corresponding to said respective input matrices, to obtain a like plurality of geometry windows containing corrected geometry features; and
e) generating, by layout reassembly of said plurality of geometry windows in overlapping sequence, a corrected mask design corresponding to said uncorrected layout geometry.

2. The method of claim 1 wherein said neural network is trained by a supervised training process comprising the steps of:
a) scanning in correspondence a source mask design representing a known layout geometry, and a corrected source mask design, representing a known corrected layout geometry, to define respective sequential pluralities of training windows representing geometry subsets of said source mask design said corrected source mask design;
b) encoding, for each said geometry subset, a predetermined defined subset of said geometry features as respective input matrices; and
c) providing said respective input matrices to said neural network.

3. The method of claim 2 wherein said step of generating includes the steps of:
a) selecting a central sub-portion from each of a subset of said geometry windows; and
b) combining said central sub-portions to provide said corrected mask design.

4. The method of claim 3 wherein the overlap of said sequentially overlapping plurality of windows defines said central sub-portions of said subset of geometry windows.

5. The method of claim 4 wherein said overlap is in the range of 2 and 20 percent of the same axis of said sequentially overlapping plurality of windows

6. The method of claim 5 wherein the overlap of said sequentially overlapping plurality of windows is uniform in two dimensions.

7. The method of claim 6 wherein said sequentially overlapping plurality of windows have uniform dimensions of less than two microns.

8. A computer system for generating an optical proximity corrected mask design given a target mask design, said computer system comprising:
a) a first processor operative to process a target data file representing a target mask design through a feature trained neural network to obtain an primary OPC data file representing a OPE corrected mask design, wherein said feature trained neural network is configured as a 2-dimensional multilayer back-propagation feedforward neural network to perform an optical proximity correction of geometric features represented in said target data file;
b) a second processor operative to process said target data file through a rule processor to obtain a sub-resolution feature data file representing a sub-resolution corrected mask design, wherein said rule processor is configured to perform placement of sub-resolution geometric features relative to geometric represented in said target data file; and
c) a layout reassembler operative to merge said primary OPC and sub-resolution feature data files to generate a combined OPC data file representing an overlaid composition of said OPE and sub-resolution corrected mask designs.

9. The computer system of claim 8 wherein said rule processor includes a 2-dimensional multilayer back-propagation feedforward neural network trained for sub-resolution feature placement.

10. The computer system of claim 9 wherein said first processor is operative to process said target data file through said feature trained neural network as a sequence of first data file subsets respectively representing a series of overlapping window portions of said target mask design.

11. The computer system of claim 10 wherein said feature trained neural network is trained on a coordinated sequence of overlapping window portions from training mask designs, and wherein said first processor is operative to assemble sub-portions of the data produced through said feature trained neural network to obtain said primary OPC data file.

12. The computer system of claim 11 wherein said first processor is operative to selectively assemble core area sub-portions of the data produced through said feature trained neural network to obtain said primary OPC data file.

13. A method, implemented on a computer system, for generating an optical proximity corrected mask design given a target mask design, said method comprising the steps of:
a) scanning a target mask design to obtain a first coordinated series of overlapping windows of target mask design data;
b) first processing said first coordinated series through a first neural network to obtain a second like coordinated series of overlapping windows of primary OPE corrected target mask design data, wherein said first neural network is trained from mask design data excluding sub-resolution features;
c) second processing said first coordinated series through a second neural network to obtain a third like coordinated series of overlapping windows sub-resolution mask design data, wherein said second neural network is trained from first mask design data excluding sub-resolution features and second mask design data exclusively including sub-resolution features; and
d) merging said second and third like coordinated series to produce an OPE corrected mask design.

14. The method of claim 13 wherein said step of merging includes the steps of:
a) assembling sub-selected portions of said second like coordinated series to produce a first corrected mask design;
b) assembling sub-selected portions of said third like coordinated series to produce a second corrected mask design; and
c) compositing said first and second corrected mask designs to produce said OPE corrected mask design.

15. The method of claim 14 wherein the sub-selected portions of said second like coordinated series and the sub-selected portions of said third like coordinated series are topologically corresponding abutting core areas.

16. The method of claim 15 wherein the overlap of said first coordinated series is in the range of 2 and 20 percent of the same axis of the overlapping windows of target mask design data.

17. The method of claim 16 wherein the overlap of said first coordinated series is uniform in two dimensions.

18. The method of claim 17 wherein the windows of said first coordinated series have uniform dimensions of less than two microns.
